(19) United States
(12) Patent Application Publication
(10) Pub. No.: US 2003/0051110 A1
(43) Pub. Date: Mar. 13, 2003

(54) Self mirroring disk drive

(76) Inventors: Walter A. Gaspard, Cypress, TX (US); Jeff W. Wolford, Spring, TX (US); Eric N. Heiney, Magnolia, TX (US)

Correspondence Address: CONLEY ROSE, P.C., P. O. BOX 3267, HOUSTON, TX, 77253-3267, US

(21) Appl. No.: 09/949,987

(22) Filed: Sep. 10, 2001

(51) Int. Cl. G06F 13/00

(52) U.S. Cl. 711/162

(57) ABSTRACT

The present invention relates to a method and apparatus for mirroring user data on a single hard drive. Each block of user data is written to the rotating disk or platter of the hard drive at two locations. Those two locations are on at least different surfaces of at least one platter of the hard drive system, and are also at starting locations 180° out of phase from each other. In this way, the loss of data at one of the locations on the rotating disk or platter may not be a catastrophic loss as the data block is also written on a different surface starting at a different location. In this way, user data is protected from loss caused by physical damage, mobile particulates within the sealed volume of the hard drive, and other write problems such as high fly writes.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to hard drives for computer systems. More particular, the present invention relates to a hard drive for a computer system that does self mirroring of user data for data integrity purposes.

2. Background of the Invention

Early computer systems had no hard drives. The user stored the desired program on floppy disks that were inserted as necessary into the floppy drive of the computer, where the program was read and executed. Soon thereafter the first hard drives were introduced in computer systems. These hard drives had the advantage that they could store many of a computer user's programs on a single disk. These early hard drives had storage capacities of 30 megabytes or less.

Hard drive technology since then, however, has significantly outpaced the need for storage capacity. For example, hard drive manufacturers today make drives with the capability of storing 20 gigabytes on each side of the rotating platter or disk. Considering that these platters or disks are typically two-sided, for a very small increase in bill of materials cost the manufacturer can double that capacity to 40 gigabytes by using the second side of the platter. However, most personal computer users do not need this additional 20 gigabytes of storage space, and are not inclined to pay extra for the unneeded capacity.

The typical personal computer user may never use storage capacity in the 40 gigabyte range. These personal computer users do, however, have data integrity and reliability worries that industrial users have. For example, it may be devastating to a personal computer user to lose information stored on the single hard drive of the computer system. Industrial computer users typically employ a redundant array of independent disks (RAID) system to achieve data integrity. In the most basic RAID system, each block of information is written to at least two hard drives. Thus, if one hard drive fails, the information may still be accessible on the redundant or mirror drive. These RAID-type systems, however, are cost prohibitive for personal computer users (they require at least two complete hard drives) and, because of space considerations, may not be available at all for laptop computer users. The excess storage capacity on modem hard drives may, however, be put to other uses.

U.S. Pat. No. 6,163,422 (hereinafter the '422 patent) assigned to EMC Corporation discusses a use for the excess capacity on modem hard drives; however, the '422 patent concerns managing the information stored on the disk to improve data access performance. In particular, the '422 patent discloses that user data stored on a hard drive should be physically written to the rotating disk or platter of that hard drive twice: first at a location along a particular track; and then that same data written immediately thereafter to the same side of the disk starting at a point half way around the disk (180° out of phase).

Improved hard drive performance in the '422 disclosure takes place as a function of how long it takes the starting location of any string of data on a particular track to reach the read/write head of the hard drive. If, for example, the data is written only once, the starting point to read this information only appears under the read/write head once per revolution of the disk. If the information is written twice at locations 180° out of phase, the maximum possible latency is cut in half. As an example, consider that the hardware of a hard drive writes a block of data. Sometime thereafter, a component of the computer system requests that block of data from the disk. Further suppose that the request comes just after the starting point for reading that data has passed the read/write head. For a disk or platter rotating at 5400 revolutions per minute (RPM), the starting point for reading that data will not be under the read/write head again for approximately 11 milliseconds. Likewise, if the disk platter has an operational rotating speed of 7200 RPM, 8.3 milliseconds may pass before that data is again available under the read/write head. If as disclosed in the '422 patent the data is written twice on the same side of the disk or platter at starting locations 180° out of phase, the data will be available for reading a mere one-half revolution of the disk, cutting the maximum possible latency times in half.

Any data reliability/recovery mechanisms discussed in the '422 patent are tangential to its primary goal of increasing system performance. The '422 disclosure provides no protection, for example, from mobile particulate contamination of the disk or platter. Further, the tangential reliability increases of the '422 patent would not protect a user from physical damage to the platter at issue.

Thus, what is needed is a mechanism to increase data reliability and recoverability for personal computer users that utilizes excess drive capacity common in modem hard drive systems.

### BRIEF SUMMARY OF THE INVENTION

The problems noted above are solved in large part by a hard drive system that performs mirroring of data for data reliability and recovery purposes within a single hard drive. More particularly, an embodiment comprises a hard drive having at least a single rotating disk or platter. Preferably, each surface of the disk or platter is capable of storing user data and each surface has associated therewith a read/write head held in place by an arm or actuator. A positioning unit positions the read/write heads over particular portions of the disk or platter by rotating the arm to which the read/write heads attach.

The preferred embodiments write a block of data to a first side of the disk or platter at a first location. Sometime thereafter, the same block of data is written again to the second side of the disk or platter at a starting location 180° out of phase. Thus, the information is stored in two separate locations on different sides of the disk. In the event that the data written to the first location cannot be read or corrected using known means, the second set of information may be read, thereby facilitating data integrity by mirroring within a single hard drive.

Writing the information at least twice in this manner protects the computer user's data from failures such as physical damage to one side of the disk or platter, problems associated with high-fly writes, and mobile particulate settling on one side of the disk.

### BRIEF DESCRIPTION OF THE DRAWINGS

For a detailed description of the preferred embodiments of the invention, reference will now be made to the accompanying drawings in which:

FIG. 1 shows a computer system in accordance with an embodiment of the invention;

FIG. 2 shows a partial schematic of a hard drive of an embodiment of the invention; and

FIG. 3 shows a partial elevation view of the rotating disks of a hard drive.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. For example, the term hard drive is used throughout the specification to mean the semi-permanently mounted rotating disk system common in most computer systems. This hard drive may alternately be referred to as a fixed disk, hard disk drive, and the like.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

Further, the term hard drive refers to a complete disk drive assembly, including all the electronics, that couples to a computer system, typically by a bus connector and a power connector. In contrast, the terms disk or platter refer to an individual component within the hard drive that comprises the actual storage medium onto which the bits of information are placed.

### DETAILED DESCRIPTION OF THE PREFERRED EMBODIMENTS

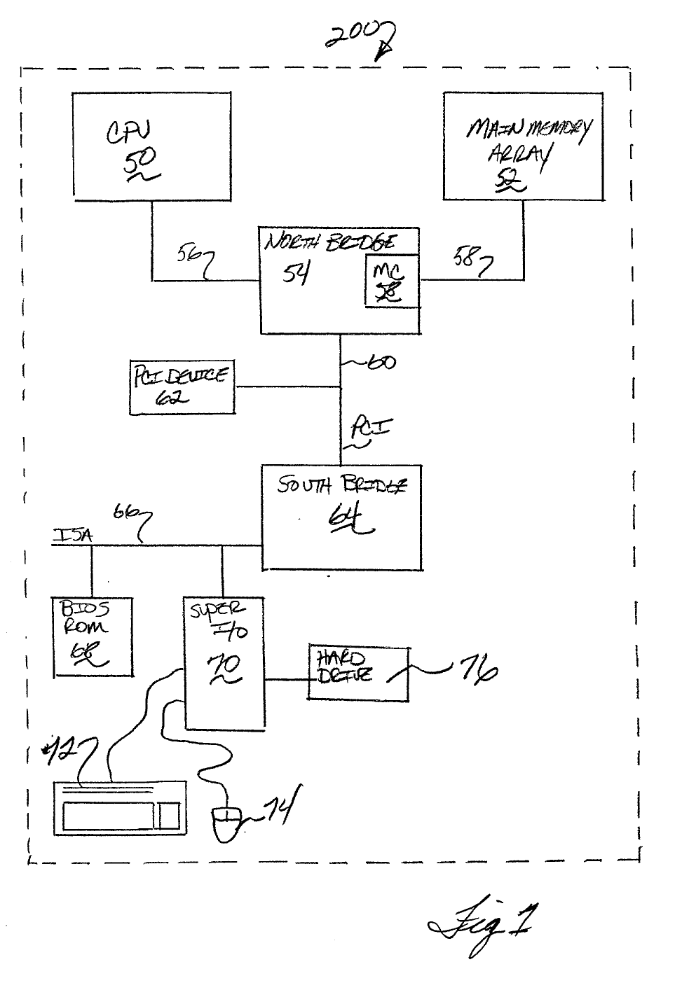

Referring now to FIG. 1, computer system 200, in accordance with an embodiment preferably comprises a micro-processor or CPU 50 coupled to a main memory array 52 through an integrated bridge logic device 54. As depicted in FIG. 1, the bridge logic device 54 is sometimes referred to as a “North bridge,” based generally upon its location within a computer system drawing. The CPU 50 preferably couples to the bridge logic 54 via a CPU bus 56, or the bridge logic 54 may be integrated into the CPU 50. The CPU 50 preferably comprises a Pentium III® microprocessor manufactured by Intel®. It should be understood, however, that other alternative types and brands of microprocessors could be employed.

The main memory array 52 preferably couples to the bridge logic unit 54 through a memory bus 58, and the bridge logic 54 preferably includes a memory control unit 57 that controls transactions to the main memory by asserting the necessary control signals during memory accesses. The main memory array may comprise any suitable type of memory such as dynamic random access memory (DRAM), any of the various types of DRAM devices, or any memory device that may become available in the future.

The North bridge 54 bridges various buses so that data may flow from bus to bus even though these buses may have varying protocols. In the computer system of FIG. 1, the North bridge 54 couples to a primary expansion bus 60, which in the preferred embodiment is a peripheral component interconnect (PCI) bus. FIG. 1 also shows a PCI device 62 coupled to the primary expansion bus 60. PCI device 62 may be any suitable device such as a modem card or a network interface card (NIC). One skilled in the art will realize that multiple PCI devices may be attached to PCI bus 60, yet for clarity of the figure, only one is shown.

An embodiment of computer system 200 further includes a second bridge logic device, a South bridge 64, coupled to the primary expansion bus 60. This South bridge 64 couples, or bridges, the primary expansion bus 60 to other secondary expansion buses. These other secondary expansion buses may include an industry standard architecture (ISA) bus 66, a sub-ISA (not shown), a universal serial bus (not shown), and/or any of a variety of other buses that are available or may become available in the future. In the embodiment shown in FIG. 1, the South bridge 64 bridges Basic Input Output System (BIOS) Read Only Memory (ROM) 68 to the primary expansion bus 60, therefore, programs contained in the BIOS ROM 68 are accessible by the CPU 50. Also attached to the ISA bus 66 is Super Input/Output (Super I/O) controller 70, which controls many system functions, including interfacing with various input and output devices, such as keyboard 72. The Super I/O controller 68 may further interface, for example, with a system pointing device such as a mouse 34, various serial ports (not shown) and hard drive 76. The Super I/O controller is often referred to as “super” because of the many I/O functions it may perform.

The BIOS ROM 68 preferably contains firmware embedded on a ROM memory chip and performs a number of low-level functions. For example, the BIOS executes the power on self test (POST) during system initialization (“boot-up”). The POST routines test various subsystems in the computer system, isolate faults and report problems to the user. The BIOS is also responsible for loading the operating system into the computer's main system memory. Further, the BIOS handles the low-level input/output transactions to the various peripheral devices such as the hard drive 76.

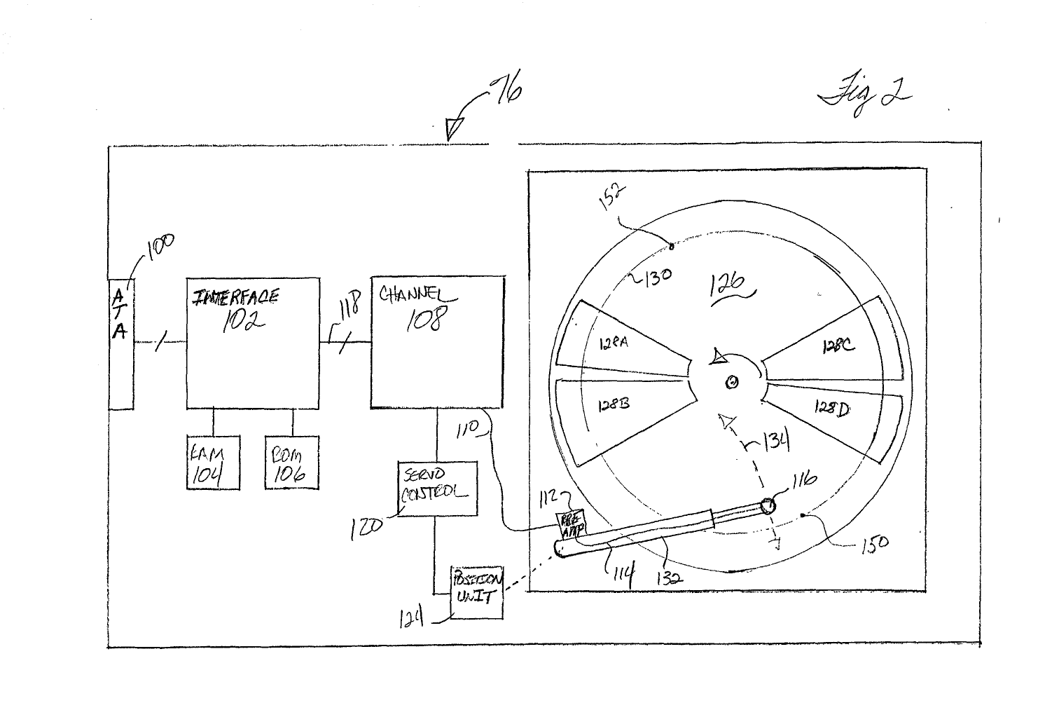

FIG. 2 shows in greater detail the hard drive 76. In particular, hard drive systems typically contain a parallel interface, which in the preferred embodiment is an AT Architecture (ATA) interface 100. Components external to the hard drive 76 preferably communicate through the ATA 100 to the interface circuit 102. The interface 102 is the heart of the hard drive system and may itself contain a microprocessor unit for performing the tasks necessary for storing and retrieving data for the computer system user. The interface circuit preferably couples to a RAM device 104 and a ROM device 106. The ROM device 106 preferably contains software suitable for booting the microprocessor (not shown) of the interface circuit 102. As one of ordinary skill in the art is aware, this ROM 106 code may be as simple as directing the microprocessor to read necessary operating software stored on the rotating disk, or as complex as storing all the necessary software on the ROM itself. The RAM 104 is preferably used as a buffer or storage area for data written to or read from the hard drive 76. For personal computer users, the size of this RAM may be as small as 512 kilobytes, and for large industrial users the size of the RAM can be 2 megabytes or more. Because the hard drive 76 of the preferred embodiment implements a self-mirroring feature that need not immediately write duplicate sets of data, the preferred RAM 104 size is at least 2 megabytes.

The interface circuit 102 couples to the channel circuit 108. The channel circuit 108 takes digital information supplied from the computer system (through the interface 102) and converts that information into analog signals applied to line 110. The analog signals feed to a bi-directional preamp 112, and then through line 114 to the read/write head 116. In the case where data is written, the channel circuit applies the necessary voltages to the line 110 based on the digital signals applied through bus 118. In the case where data is read, the channel circuit takes the series of analog signals representing data on the rotating disk, and converts those into digital signals that transfer across bus 118 to the interface circuit 102. The timing of application of the various voltage levels during data writes corresponds to the location of the read/write head above the disk, discussed more fully below. Channel circuit 108 further preferably couples to a servo control circuit 120. The servo control circuit 120 positions the read/write head by control of the positioning unit 124, which rotates arm 132. The positioning unit 124 preferably comprises a bobbin of coil wires (not shown) attached to the end of the arm 132. The electric field created by current flow in the bobbin of coil wires interacts with the magnetic field of a permanent magnet (not shown) which creates force to move and position the arm 132.

As one of ordinary skill in the art is aware, the rotating disk or platter 126 is the actual physical medium upon which data is impressed for long term storage. Logically, the platter is divided into a plurality of wedges or sectors 128. In the embodiment shown in FIG. 2, only four such wedges or sectors 128 are shown for clarity of the drawing, however it is understood that this logical arrangement exists around the entire platter 126.

Information is stored to the disk or platter 126 as it rotates. Thus, the disk is further logically divided into a plurality of circular tracks, only one of which is shown in FIG. 2 as track 130. Track 130 preferably intersects each sector or wedge 128 on the platter 126. Typically, 512 kilobytes of information, inclusive of data integrity devices such as error correction codes, are contained within the track in each sector or wedge.

Read/write head 116 is physically connected to an actuator or arm 132. By operation of positioning unit 124, the arm 132 positions the read/write head 116 over each track (for example, track 130) of the platter 126. The arm 132 is capable of moving in an arcuate fashion as indicated by dashed line 134 such that the read/write head 116 may be positioned over each track on that particular side of the disk or platter 126.

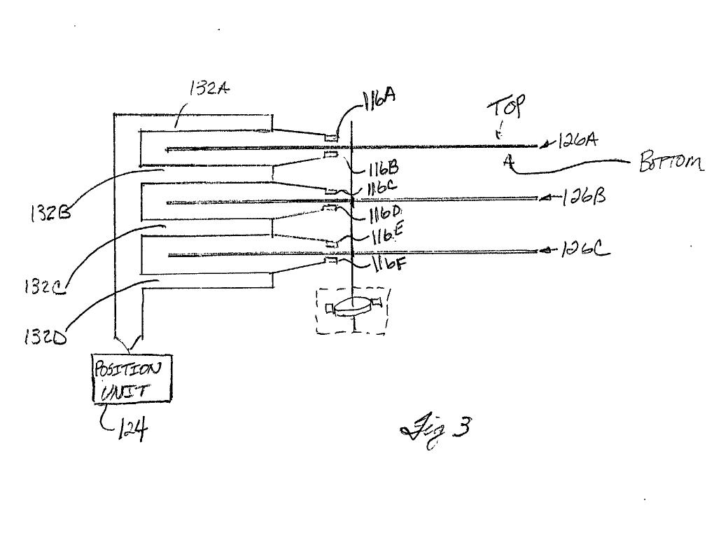

FIG. 3 shows a somewhat cross-sectional view of the platters of a hard drive. While FIG. 3 shows three such platters 126A-C, it must be understood that the preferred embodiments of the present invention are not limited to any particular number of disks, so long as at least two storage surfaces are available. In fact, given the current state of hard drive technology, as many as five platters 126 may be placed in a hard drive 76 having a one inch profile. Typically, however, only industrial users or server systems utilize hard drives 76 having this many platters. Typical consumer hard disks have only a single platter 126.

Still referring to FIG. 3, each arm or actuator 132A-D connects to the positioning unit 124. The positioning unit 124 is capable of positioning only one of the heads 116A-F at any one time because the tracks on each side of each platter 126A-C do not precisely line up. This deficiency in read/write head positioning technology may be addressed in the future; however, the principles described herein are equally applicable if technology advances such that simultaneous reading and writing by multiple read/write heads 116 becomes possible.

The physical location of the data written to each particular platter in the preferred embodiments is a function of the most common failure modes of a hard drive 76. The failure modes the preferred embodiments attempt to address are physical damage to a surface of the platter, mobile particulates within the sealed portion of the hard drive 76 that mask reading and writing of data, and blind-writes. The physical damage and mobile particulate failure modes may be related in that physical damage to one surface of the platter may create mobile particulates which themselves create data integrity problems.

Physical damage is damage to the magnetic surface of a platter 126 possibly caused by a read/write head 116 contacting the platter surface. Considering that disks or platters 126 in most commercial applications rotate in the range of 5400 to 7200 RPM, physical contact of the read/write write head 116 with a surface of the platter 126 causes a scratch or other catastrophic damage. The scratch itself may remove sufficient magnetizable material that the information stored at that location is lost. Further, the physical contact may create particulate matter within the sealed unit of the hard drive 76. This particulate matter typically settles on upward facing surfaces of platters within the sealed unit of the disk. Particulate matter may mask or hide otherwise viable information, making it unreadable.

The third problem addressed by the preferred embodiments are problems associated with “blind-writes.” Although modem hard drives 76 are very efficient at storing information to their disks or platters 126, there is no guarantee that the fields created around the read/write head 176 actually place the information at the locations desired. To compensate for this, some hard drive systems write the information, read the information back, and compare it to make sure that all the information was properly stored. If there are discrepancies, the information may be rewritten at that location or other locations until the read and write comparison shows proper storage. One technique for increasing performance in disk drive systems where data write reliability is high is to perform “blind-writes.” In a blind write, the information is written to the disk, but that information is not read back or compared. A user may not know that any problem has occurred in writing information until it is read again at some later time, and found to be unusable.

The problems associated with blind-writes manifest themselves in a related problem known as a “high-fly” write. As technology advances, components become smaller and closer together. This is true even for the read/write heads and their relationship to the rotating disks or platters 126. These placements are so close in fact that small imperfections on the surface of the rotating disk or platter may cause the read/write head to move away from the surface of the disk or platter. That is, the read/write head may move upward to track a bump on the surface of the platter 126. If that bump has relatively steep slopes, it may take a certain amount of time for that read/write head to settle back to its required elevation from the surface of the disk or platter. In the time that the read/write head is settling back down, it may be too far from the surface to write information to the magnetizeable material thereon. Thus, the read/write head is attempting to write information as it is “flying” too high above the surface of the disk or platter, hence the name “high-fly” write. If the computer system is operating in a blind-write mode, this high-fly write may not be detected until the information is later read.

The preferred embodiments of the present invention comprise a hard drive 76 that has the capability of performing self-mirroring. This self-mirroring capability has two major facets: first, blocks of data are preferably written at two separate locations on the platters of the hard drive 76; and second, these two locations are not on the same side of the same platter 126.

In the first facet, the block of information is preferably written to a first side of a first platter, for example, the top of platter 126A (FIG. 3). The data block is preferably written again at some subsequent time to a different surface of the platters within the hard drive 76. This different surface could be, for example, the bottom of platter 126A or any other surface of the platters 126B or 126C of FIG. 3. Data is preferably written in this fashion to protect from loss caused by physical damage and mobile particulates. As indicated above, these particulates typically settle on the upper surface of platters within the disk drive 76 system. By writing the information on two different surfaces, the chances of losing data because of physical damage or mobile particulates is significantly reduced. While in this example, data was written to the top and bottom of the same platter 126, this is only exemplary, and the data may be written to any other surface of any other platter 126 that resides in the hard disk 76. It must be understood, however, that for a typical consumer hard drive 76, only one platter is present and therefore each data block is preferably written on the top surface and the bottom surface of that platter.

In addition to writing each block of data on different surfaces of platters 126 within the hard drive 76, the beginning point of writes is offset. Referring again to FIG. 2, platter 126 is shown to have a track 130 that extends in a circle around the surface. Consider for purposes of discussion, and not as a limitation on the claims, the two points marked 150 and 152. If the point 150 on track 130 is considered to be a starting location for an exemplary write of data (a 0° point), then point 152 of track 130 is 180° out of phase from point 150. With this in mind, the preferred embodiments of the present invention not only write the data twice on different surfaces of one or more platters, but also preferably start the data block writes at positions 180° out of phase. Stated otherwise, the starting points for each write preferably differ in angular displacement by 180°. By making the beginning points for each of the two writes 180° of phase, the user data is protected both from physical damage (it is unlikely that physical damage on one portion of the rotating disk or platter will also be present a half-revolution away) and from blind-writes and high-fly write problems (imperfections that cause a high-fly write on one particular surface of a disk or platter are most likely not present at the location 180° out of phase.)

Referring to FIGS. 2 and 3 simultaneously, consider an exemplary write of information in the preferred embodiment. First, the hard drive circuitry writes that information starting at the exemplary point 150 (0°) of track 130 on the upper surface of platter 126. Preferably, the hard drive circuitry writes that same information on some other surface, for example, the bottom of platter 126 or any other of the surfaces shown in FIG. 3, but it is also written starting at a point 180° out of phase from the write on the top surface of platter 126. Although point 152 (the 180° point) is shown on the same surface as point 150 in FIG. 2, it must be understood that the beginning point for the write is preferably at that location, but on a different surface of the platter, or on some other platter.

Timing for the multiple writes is not critical. It is not necessary that the two identical blocks of information be written in series. There may be many intervening reads and writes between when the first copy of the data is written, and when the second copy is written. As mentioned above, the typical personal computer hard drive 76 has 512 kilobytes of onboard RAM as buffer space. Because the lack of a constraint as to when the duplicate copies of data blocks are written, the size of the RAM and therefore the buffer within the hard drive 76 is preferably larger than a typical consumer hard drive buffer, preferably 2 megabytes or more.

One of ordinary skill in the art, now understanding the principles of the present invention, can easily see that in some implementation the preferred embodiments require no additional hardware other than what is already present in a hard drive 76. That is, except for adding RAM to increase the size of the buffer (which some industrial hard drives already have buffers of sufficient size), implementation of the entire invention could be done by upgrading the ROM and operational software of the microprocessor (not shown) of the interface circuit 102.

The above discussion is meant to be illustrative of the principles and various embodiments of the present invention. Numerous variations and modifications will become apparent to those skilled in the art once the above disclosure is fully appreciated. For example, the preferred embodiments described require multiple writes of data beginning at locations 180° out of phase. One of ordinary skill in the art, now understanding the principals of the invention, will realize that the starting points need not be 180° out of phase to obtain the data reliability and recovery aspects of the invention. This procedure merely increases the reliability and recoverability feature. Further, the internal specifics of the hard drive 76 are merely exemplary and different hard drive manufacturers may have slightly different components, yet those components operating in the manner described herein would still be within the contemplation of this invention. Further, the specification discloses that each block of data is written at two separate locations within the hard drive. However, one of ordinary skill in the art now understanding the principles of the invention could implement a similar system using RAID technology. In particular, it would be possible that rather than writing each block of data at the separate locations, that the data is divided into small subsets and distributed across the multiple locations, and including a set of error correction or parity information such that loss of any one particular subset of data would not result in the overall loss of data (because that subset can be reproduced based on the error correction codes). However, in the implementation of the preferred embodiments for consumer use, where drive capacity is not an issue, these complex RAID-type systems will only complicate implementation and slow information delivery from the hard drive. It is intended that the following claims be interpreted to embrace all such variations and modifications.

What is claimed is:

1. A computer system, comprising:
a processor;
a system memory coupled to the processor;
a first bridge logic device coupling the processor and the system memory;
a primary expansion bus coupled to the first bridge logic device;
a second bridge logic device coupled to the first bridge logic device via the primary expansion bus; and
a hard drive coupled to the second bridge logic device, the hard drive having a rotating platter having a first and second surface;
wherein the hard drive is adapted to write each block of user data on both the first surface and the second surface.

2. The computer system as defined in claim 1 wherein the hard drive further comprises:
a track on the first surface of the platter;
a track on the second surface of the platter;
said user data written beginning at a starting location on the track of the first surface; and
said user data written beginning at a starting location on the track of the second surface;
wherein the starting location of the track on the first surface and the starting location of the track on the second surface differ in angular displacement.

3. The computer system as defined in claim 2 wherein the starting location of the track of the first surface and the starting location of the track of the second surface differ in angular displacement by 180 degrees.

4. The computer system as defined in claim 1 wherein the hard drive further comprises:
an interface coupling the hard drive to the second bridge logic device;
an interface circuit coupled to the interface;
a random access memory (RAM) device coupled to the interface circuit, the RAM adapted to act as a buffer for data transfer to and from the hard drive; and
said buffer has a storage capacity of at least two megabytes.

5. The computer system as defined in claim 4 wherein said interface is an AT Architecture (ATA) interface.

6. The computer system as defined in claim 4 wherein said interface circuit contains a microprocessor.

7. A method of increasing data reliability within a single hard disk drive, the method comprising:
writing a block of user data to a surface of a first rotating platter;
writing the block of user data to a surface of a second rotating platter;
reading the block of user data from the surface of the first rotating platter; and if the reading from the first rotating platters fails; and
reading the block of user data from and the surface of the second rotation platter.

8. The method as defined in claim 7 further comprising:
writing the block of user data to the first rotating platter and the second rotating platter where the first and second rotating platters are the same platter having a first and second surface; and
writing the user data to the first surface and again to the second surface of the rotating platter.

9. The method as defined in claim 8 further comprising:
beginning the write of the user data at a beginning location on the first surface;
beginning the write of the user data at a beginning location of the second surface; and
offsetting the beginning locations of the first and second surface.

10. The method as defined in claim 9 wherein said offsetting further comprises offsetting the beginning of the write at the first location from the write at the second location by 180 degrees.

11. A structure of a hard disk drive for a computer system, comprising:
an interface adapted to couple the hard disk drive to the computer system;
an interface circuit coupled to the interface;
a random access memory (RAM) device coupled to the interface circuit, the RAM adapted to act as a buffer for data transfer to and from the hard disk drive;
a read only memory (ROM) device coupled to the interface circuit, the ROM adapted to store at least part of a set of software required to operate the disk drive;
a channel circuit coupled to the interface circuit;
a servo motor control circuit coupled to the channel circuit, the servo motor control circuit adapted to control a positioning unit that positions an arm;
a rotating platter having a first and second surface; and
a read/write head in operational relationship to each of the surfaces;
wherein the hard disk drive mirrors user data by writing the user data on the first and second surfaces of the rotating platter.

12. The hard disk drive as defined in claim 11 further comprising:
two rotating platters, each platter having at least one surface;
wherein the hard disk drive mirrors the user data by writing the user data to a surface of each of the two rotating platters.

13. The hard disk drive as defined in claim 11 further comprising:
a track on the first surface of the platter;
a track on the second surface of the platter;
said user data written starting at a first location on the track of the first surface; and
said user data written starting at a first location on the track of the second surface;
wherein the first location on the track on the first surface and the first location on the track on the second surface differ in angular displacement.

14. The hard disk drive as defined in claim 13 wherein the first location on the track of the first surface and the first location on the track of the second surface differ in angular displacement by 180 degrees.

15. The hard disk drive as defined in claim 14 further comprising:
two rotating platters, each platter having a surface;
wherein the hard disk drive mirrors the user data by writing the user data to a surface of each of the two rotating platters.

16. A method of increasing long term data storage reliability in the operation a computer system comprising:
transferring a set of user data to a hard drive;
receiving the user data in a buffer in the hard drive;
writing the user data to a write surface of a first rotating disk; and sometime thereafter writing the user data again to a write surface of a second rotating disk;
reading the user data from the write surface of the first rotating disk; and, if this read fails, reading the user data from the write surface of the second rotating disk.

17. The method as defined in claim 16 further comprising:
wherein writing the user data to the first rotating disk further comprises beginning said write of user data at a starting location;
wherein writing the user data to the second rotating disk further comprises beginning said write of user data at a starting location; and
shifting in angular displacement the starting location of the write of user data on the first rotating disk from the starting location of the write of user data on the second rotating disk.

18. The method as defined in claim 17 wherein said shifting further comprises:
shifting in angular displacement the starting location of the write of user data on the first rotating disk from the starting location of the write of user data on the second rotating disk by 180 degrees.

19. The method as defined in claim 16 wherein the writing steps further comprise writing the user data to a single rotating disk having a first and second surfaces, said user data written to said first surface, and sometime thereafter to said second surface.

20. The method as defined in claim 19 further comprising:
wherein writing the user data to the first surface further comprises beginning said write of user data at a starting location;
wherein writing the user data to the second surface further comprises beginning said write of user data at a starting location; and
shifting in angular displacement the starting location of the write of user data on the first surface from the starting location of the write of user data on the second surface.

21. The method as defined in claim 20 wherein said shifting further comprises:
shifting in angular displacement the starting location of the write of user data on the first surface from the starting location of the write of user data on the second surface by 180 degrees.

22. A structure of a hard disk drive for a computer system, comprising:
a means for coupling the hard disk drive to the computer system;
an interface means coupled to the coupling means, said interface means interfacing the hard disk drive to the computer system;
a buffer means for buffering data transfers to and from the hard disk drive;
a software storage means adapted to store a set of software required to operate the hard disk drive;
a rotating storage medium having two surfaces; and
a read/write means for reading to and writing from said rotating disk, said read/write means in operational relationship to the rotating storage medium;
wherein the hard disk drive mirrors user data by writing the user data on at least two different surfaces of the rotating storage medium.

23. The hard disk drive as defined in claim 22 wherein the rotating storage medium further comprises:
two rotating platters, each platter having a surface;
wherein the hard disk drive mirrors the user data by writing the user data to a surface of each of the two rotating platters.

24. The hard disk as defined in claim 22 wherein said rotating storage medium further comprises a rotating platter having a first and second surface.

25. The hard disk drive as defined in claim 24 further comprising:
a track on the first surface of the platter;
a track on the second surface of the platter;
said user data written starting at a first location on the track of the first surface; and
said user data written starting at a first location on the track of the second surface;
wherein the first location on the track on the first surface and the first location on the track on the second surface differ in angular displacement.

26. The hard disk drive as defined in claim 25 wherein the first location on the track of the first surface and the first location on the track of the second surface differ in angular displacement by 180 degrees.

27. The hard disk drive as defined in claim 26 further comprising:
two rotating platters, each platter having a surface;
wherein the hard disk drive mirrors the user data by writing the user data to a surface of each of the two rotating platters.
